(19) United States
(12) Patent Application Publication
(10) Pub. No.: US 2026/0116433 A1
(43) Pub. Date: Apr. 30, 2026

(54) Method and Apparatus for Autonomous Control of Vehicle

(71) Applicants: Hyundai Motor Company, Seoul (KR); Kia Corporation, Seoul (KR)

(72) Inventor: Sa Heon Song, Hwaseong-Si (KR)

(21) Appl. No.: 19/229,084

(22) Filed: Jun. 5, 2025

(30) Foreign Application Priority Data
Oct. 25, 2024 (KR) 10-2024-0147232

(51) Int. Cl. B60W 60/00; B60W 10/18; B60W 40/08; B60W 50/14; B60W 50/16; G06V 10/82; G06V 20/59; G06V 40/16

(52) U.S. Cl. CPC B60W 60/0016; B60W 10/18; B60W 40/08; B60W 50/16; G06V 10/82; G06V 20/59; G06V 40/174; B60W 2050/143; B60W 2050/146; B60W 2420/403; B60W 2420/54; B60W 2520/10; B60W 2556/20; G06V 2201/07

(57) ABSTRACT

A method performed by an apparatus for autonomous control of a vehicle is introduced. The method comprises determining whether a speed of the vehicle is equal to or less than a preset speed, specifying a passenger of the vehicle as a monitoring target, determining, by monitoring the passenger, whether the passenger indicates a potential risk associated with the vehicle, determining, based on a determination that the passenger indicates the potential risk, whether the potential risk qualifies as a dangerous situation, generating, based on a determination that the potential risk qualifies as the dangerous situation, a signal indicating the dangerous situation, and performing, based on the signal, autonomous control of the vehicle.

### CROSS-REFERENCE TO RELATED APPLICATION

This application claims the benefit of priority to Korean Patent Application No. 10-2024-0147232, filed in the Korean Intellectual Property Office on Oct. 25, 2024, the entire contents of which are incorporated herein by reference.

### TECHNICAL FIELD

The present disclosure relates to a method and apparatus for autonomous control of a vehicle. In more detail, the present disclosure relates to a method and apparatus for autonomous control of a vehicle, the method and apparatus assessing a dangerous situation by determining whether a passenger who has exited a vehicle is checking a dangerous situation or a hazardous condition.

### BACKGROUND

The matters described in this Background section are only for enhancement of understanding of the background of the disclosure, and should not be taken as acknowledgment that they correspond to prior art already known to those skilled in the art.

Drivers who navigate narrow spaces such as alleys or parking lots have difficulty assessing the surrounding situation due to limited visibility. Even with drive assistance systems of a vehicle, in narrow spaces, errors in ultrasonic and camera sensors may cause malfunctions, so it is difficult to accurately assess the surrounding situation of the vehicle. Driving the vehicle without assessing the surrounding situation of the vehicle may lead to serious accidents. In order to prevent accidents that may occur in narrow spaces, a drive assistance system may collect information from passengers to assess the surrounding situation of the vehicle, determine a dangerous situation or a hazardous condition, and control a vehicle.

### SUMMARY

A main objective of the present disclosure is to assess a dangerous situation by determining whether a passenger who has exited from a vehicle is checking a dangerous situation or a hazardous condition.

The objectives of the present disclosure are not limited to the objectives described above and other objectives will be clearly understood by those skilled in the art from the following description.

According to an example of the present disclosure, there is an effect of preventing accidents by determining a dangerous situation by determining whether a passenger who has gotten off a vehicle checks a dangerous situation.

The effects of the present disclosure are not limited to those described above and other effects may be made apparent to those skilled in the art from the claims.

The effects of the present disclosure are not limited to those described above and other effects may be made apparent to those skilled in the art from the claims.

According to the present disclosure, a method performed by an apparatus for autonomous control of a vehicle, the method may comprise determining whether a speed of the vehicle is equal to or less than a preset speed, specifying a passenger of the vehicle as a monitoring target, determining, by monitoring the passenger, whether the passenger indicates a potential risk associated with the vehicle, determining, based on a determination that the passenger indicates the potential risk, whether the potential risk qualifies as a dangerous situation, generating, based on a determination that the potential risk qualifies as the dangerous situation, a signal indicating the dangerous situation, and performing, based on the signal, autonomous control of the vehicle.

The method, wherein the specifying of the passenger as the monitoring target may comprise determining that the passenger has exited the vehicle.

The method, wherein the specifying of the passenger as the monitoring target may comprise setting, based on a pre-trained artificial intelligence learning model, a first preset time, and determining that the passenger has exited the vehicle within the first preset time after sensing opening of a door of the vehicle other than a driver's door.

The method, wherein the determining of whether the passenger indicates the potential risk may comprise determining, based on a pre-trained deep neural network model, whether the passenger is checking the potential risk condition.

The method, wherein the determining of whether the passenger indicates the potential risk may comprise stopping monitoring the passenger based on a determination that the passenger is not checking the for at least one potential risk.

The method, wherein the determining whether the passenger indicates the potential risk may comprise setting, based on a pre-trained artificial intelligence learning model, a preset distance, and determining, based on the passenger moving at least the preset distance away from the vehicle, that the passenger is not checking for at least one potential risk.

The method, wherein the determining of whether the passenger indicates the potential risk may comprise setting, based on a pre-trained machine learning model, a preset time, and determining, based on the passenger has been facing away from the vehicle for at least the preset time, that the passenger is not checking for at least one potential risk.

The method, wherein the determining of whether the potential risk qualifies as the dangerous situation may comprise determining, based on a pre-trained deep neural network model, whether the potential risk qualifies as the dangerous situation.

The method, wherein the determining of whether the potential risk qualifies as the dangerous situation may comprise receiving sensing data from a plurality of sensors, wherein the plurality of sensors may comprise at least one of a sound sensor, a vision sensor, or a vibration sensor, and detecting, based on an object detection model and the sensing data, at least one external object associated with the potential risk.

The method, wherein the determining of whether the potential risk qualifies as the dangerous situation may comprise assigning weights to the sensing data and integrating the weighted data.

The method, wherein the determining of whether the potential risk qualifies as the dangerous situation may comprise assigning a weight to sensing data received from the vision sensor that is lower than weights assigned to sensing data received from other sensors of the plurality of sensors.

The method, wherein the determining of whether the potential risk qualifies as the dangerous situation may comprise determining, based on a feature of a sound generated by the passenger, whether the sound is related to the potential risk.

The method, wherein the determining of whether the potential risk qualifies as the dangerous situation may comprise determining, based on a feature of a vibration generated by the passenger, whether the vibration is related to the potential risk.

The method, wherein the determining of whether the potential risk qualifies as the dangerous situation may comprise determining, based on a feature of an action or a facial expression generated by the passenger, whether the action or the facial expression is related to the potential risk.

The method, wherein the determining of whether the potential risk qualifies as the dangerous situation may comprise determining a degree of danger level of the potential risk.

The method, wherein the determining of whether the potential risk qualifies as the dangerous situation may comprise determining a confidence score of the potential risk and an emergency score of the potential risk, and classifying, based on the determining the confidence score and the emergency score, the potential risk into one of a plurality of risk categories.

The method, wherein the determining of whether the potential risk qualifies as the dangerous situation may comprise determining, based on a probabilistic function, the confidence score and the emergency score.

The method, wherein the performing of the autonomous control of the vehicle may comprise performing an emergency procedure, wherein the emergency procedure may comprise at least one of braking the vehicle or alerting a driver of the vehicle about the potential risk, and wherein the alerting the driver may comprise outputting an indicator of a degree of the potential risk on an output device.

According to the present disclosure, an apparatus for autonomous control of a vehicle, the apparatus may comprise at least one processor, and a memory storing at least one instruction that is configured, when executed by the at least one processor communicating with the memory, to cause the apparatus to determine whether a speed of the vehicle is equal to or less than a preset speed, specify a passenger of the vehicle as a monitoring target, determine, by monitoring the passenger, whether the passenger indicates a potential risk associated with the vehicle, determine, based on a determination that the passenger indicates the potential risk, whether the potential risk qualifies as a dangerous situation, generate, based on a determination that the potential risk qualifies as the dangerous situation, a signal indicating the dangerous situation, and perform, based on the signal, autonomous control of the vehicle.

According to the present disclosure, a method performed by an apparatus for autonomous control of a vehicle, the method may comprise detecting that the vehicle is operating at a speed below a predefined threshold, collecting sensor data associated with actions of an occupant of the vehicle, determining, based on the sensor data, whether the occupant, after exiting the vehicle, is assessing surroundings of the vehicle for a potential risk associated with the vehicle, classifying, based on the sensor data and the determining, the potential risk as a dangerous situation, generating a signal indicating the dangerous situation, and performing, based on the signal, autonomous control of the vehicle.

### BRIEF DESCRIPTION OF THE DRAWINGS

FIG. 1 shows an example of an apparatus for autonomous control according to an example of the present disclosure.

FIG. 2 shows an example of an object detection model that is used in the operation process of the apparatus for autonomous control according to an example of the present disclosure.

FIG. 3 shows an example of a process in which the apparatus for autonomous control according to an example of the present disclosure determines whether a passenger checks a dangerous situation based on an object detection model.

FIG. 4 shows an example of a process in which the apparatus for autonomous control according to an example of the present disclosure determines whether a dangerous situation has occurred based on the object detection model.

FIG. 5 shows an example of a method for autonomous control according to an example of the present disclosure.

FIG. 6 shows an exemplary computing device that can be used to implement the method according to the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The following detailed description, together with the accompanying drawings, is intended to show examples of the present disclosure and is not intended to represent the only examples in which the disclosure may be practiced.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of classifying a potential risk condition observed by a passenger of a vehicle as a dangerous situation) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of classifying a potential risk condition observed by a passenger of a vehicle as a dangerous situation) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of classifying a potential risk condition observed by a passenger of a vehicle as a dangerous situation) described herein.

Minimum risk maneuver (MRM) operation(s) may also be controlled, for example, based on one or more features (e.g., feature of classifying a potential risk condition observed by a passenger of a vehicle as a dangerous situation) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of classifying a potential risk condition observed by a passenger of a vehicle as a dangerous situation) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of classifying a potential risk condition observed by a passenger of a vehicle as a dangerous situation) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

According to the present disclosure, an apparatus for autonomous control of a vehicle may monitor whether a passenger has exited the vehicle and is assisting in detecting potential hazards. If the exited passenger notices a danger (e.g., an approaching vehicle or an obstacle, etc.), the passenger may shout, knock on the car, or make urgent gestures. The apparatus may recognize these signs from the passenger, evaluate the risk level, and may automatically initiate an emergency protocol or procedure (e.g., braking the vehicle and alerting the driver, etc.).

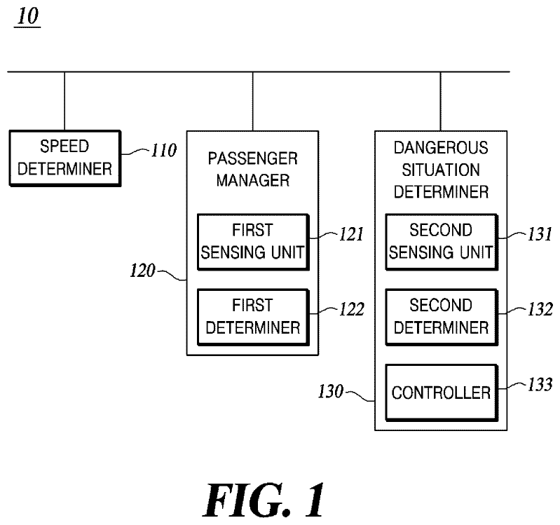

FIG. 1 shows an example of an apparatus for autonomous control according to an example of the present disclosure.

An apparatus 10 for autonomous control according to an example of the present disclosure may include all or some of a speed sensor (e.g., speed determiner 110), a passenger manager 120, and a hazard assessment circuit (e.g., dangerous situation determiner 130). Not all of the blocks shown in FIG. 1 are necessary components of the apparatus 10 for autonomous control and some blocks included in the apparatus 10 for autonomous control may be added, changed, or removed in other examples. Meanwhile, the components shown in FIG. 1 are components that are distinguished in terms of function, and at least one or more components may be implemented in an integrated type (e.g., integrated circuit/circuitry, or application specific integrated circuits (ASICs), etc.) in an actual physical environment.

The speed determiner 110 determines whether a vehicle speed does not exceed a preset speed (e.g., below 5 km/h, below 3 mph, or below a user-specified value, etc.). In this case, the preset speed may be manually set by a user or may be automatically set by the apparatus 10 for autonomous control. For example, the apparatus 10 for autonomous control may set, as the preset speed, an average speed of a vehicle that is driven in spaces with the possibility of accidents, (e.g., narrow spaces such as alleys, parking lots, or construction zones, etc.,) by analyzing the driving information of the vehicle.

The passenger manager 120 monitors (e.g., identifies and evaluates) a passenger(s) who has gotten off the vehicle. The passenger manager 120 includes a sensor (e.g., first sensing unit 121) that determines whether a door is open by collecting information from multiple sensors and a processor (e.g., a first determiner 122) that determines whether a passenger is checking a situation that satisfies a pre-set condition (e.g., collisions caused by drivers backing out, speeding, ignoring traffic rules/signs, navigating blind spots, people walking between cars or behind reversing vehicles, inattentive pedestrians, or poor lighting at night, etc.).

The first sensing unit 121 senses whether a door is open by collecting information from sensors to determine whether a passenger has gotten off. For example, the first sensing unit 121 may detect door activity (e.g., opening of doors other than the driver's door) using ultrasonic, infrared, or pressure sensors, in addition to camera-based detection, etc.

The first determiner 122 determines whether a passenger is actively assessing a dangerous situation. The first determiner 122 can determine whether a passenger is monitoring the surroundings based on AI-based assessment (e.g., using an artificial intelligence algorithm). The artificial intelligence algorithm may be a neural network algorithm. The neural network algorithm may be a deep neural network (DNN) or a convolutional neural network (CNN) and may include both of the deep neural network and the convolutional neural network. The artificial intelligence algorithm may be a model trained in accordance with a supervised learning method, an unsupervised learning method, or reinforcement learning method based on an artificial intelligence algorithm based on deep learning. The first determiner 122 can determine whether a passenger is actively evaluating a dangerous situation by performing object detection using a pre-trained neural network (e.g., DNN model). The first determiner 122 may determine whether a passenger is actively assessing a dangerous situation by performing object detection using an object detection model.

The first determiner 122 can extract information for determining whether a passenger is actively assessing a dangerous situation by analyzing information obtained from a vision-based input (e.g., an input from a camera sensor) using a deep neural network algorithm. The information for determining whether a passenger is engaged in monitoring a dangerous situation includes getting-off information (e.g., departure status), distance information (e.g., a distance between the passenger and the vehicle), and direction or orientation information (e.g., a direction the passenger faces, forward or backward).

The getting-off information is information for determining whether a passenger has gotten off. The first determiner 122 specifies a monitoring target using the getting-off information. In detail, if the first sensing unit 121 senses opening of any door except the driver's door and then senses or detects a passenger who has exited the vehicle within a set time, the first determiner 122 specifies or identifies the passenger, who has gotten off, as a monitoring target. In this case, the monitoring target may be one or more individuals (e.g., pedestrians, co-passengers, or security personnel, etc.). When the first sensing unit 121 senses opening of a door other than the driver's door and then does not sense a passenger existing the vehicle within a first preset time, the first determiner 122 determines that a passenger has not exited and does not specify a monitoring target. In this case, the first preset time may be set by AI-based assessment (e.g., the artificial intelligence algorithm of the apparatus 10) for autonomous control.

The distance information is information about the distance between a monitoring target of the apparatus 10 for autonomous control and a vehicle. The first determiner 122 determines whether to stop monitoring using the distance information. When a monitoring target remains within a preset radius or a preset threshold distance from the vehicle (e.g., within 5 meters, within 3 feet, or within a dynamically determined threshold, etc.), the apparatus 10 for autonomous control determines that the passenger is still engaged in monitoring a dangerous situation, and proceeds with continuous passenger monitoring. If a monitoring target moves beyond the preset threshold distance from the vehicle, the apparatus 10 for autonomous control determines that the passenger is no longer engaged in monitoring for a dangerous situation, and stops tracking the passenger. In this case, the preset distance may be set by the artificial intelligence algorithm of the apparatus 10 for autonomous control.

The direction or orientation information may represent orientation of the monitoring target relative to the vehicle (e.g., a monitoring target of the apparatus 10 for autonomous control faces). The first determiner 122 determines whether to stop monitoring using the direction information (e.g., head orientation, body posture, or gaze direction of the monitoring target, etc.). The first determiner 122 may extract the direction that a monitoring target faces by determining the heading direction of the monitoring target. If the monitoring target faces remains oriented toward the vehicle for a second preset time or more (e.g., at least 3 seconds, at least 2 seconds, or based on a dynamically learned threshold, etc.), the apparatus 10 for autonomous control determines that the passenger is monitoring for a dangerous situation, and proceeds with tracking the passenger. If the monitoring target looks away from the vehicle for the second preset time or more, the apparatus 10 for autonomous control determines that the passenger is not monitoring for a dangerous situation, and stops tracking the passenger. In this case, the second preset time may be set by the artificial intelligence algorithm of the apparatus 10 for autonomous control.

The dangerous situation determiner according to an example of the present disclosure may include all or some of a second sensing unit 131, a second determiner 132, and a controller 133.

The dangerous situation determiner 130 includes a second sensing unit 131 that collects data using a sensor, a hazard classifier (e.g., a second determiner 132) that determines or analyzes potential threats or a dangerous situation, and a controller 133 that controls or adjust the operation of a vehicle based on results of the analysis (e.g., a determined hazard level).

The second sensing unit 131 collects data using a sensor. The sensor may be a plurality of sensors (e.g., sound sensors, infrared sensors, LiDAR, radar, thermal cameras, or vibration sensors, etc.). The second sensing unit 131 may include a sound sensor, a camera sensor, and a vibration sensor. The second sensing unit 131 can convert collected data into a type that can be input to the hazard classifier (e.g., the second determiner 132) through featurizing (e.g., data transformation techniques such as feature extraction, dimensionality reduction, or signal processing, etc.). Featurizing is a process of converting original data into a format that a machine learning model can understand. The second sensing unit 131 can perform featurizing such as preprocessing collected data or extracting/converting the features of collected data in accordance with a method trained using an artificial intelligence algorithm.

The hazard classifier (e.g., second determiner 132) proceeds with learning for determining whether a dangerous situation has occurred using information input from the second sensing unit 131. The second determiner 132 can proceed with learning for determining whether a dangerous situation has occurred using an artificial intelligence algorithm. The artificial intelligence algorithm may be a neural network algorithm. The neural network algorithm may be a deep neural network (DNN) or a convolutional neural network (CNN) and may include both of the deep neural network and the convolutional neural network. The artificial intelligence algorithm may be a model trained in accordance with a supervised learning method or an unsupervised learning method based on an artificial intelligence algorithm based on deep learning.

The second determiner 132 proceeds with learning for determining whether a dangerous situation has occurred based on diverse sensory inputs (e.g., auditory warnings, impact detection, or emergency gestures, etc.). The second determiner 132 can perform machine learning by extracting and vectorizing sounds that occur in dangerous situations. Sounds that occur in dangerous situations include repetitive and loud sounds, such as ‘Oh! Oh! Oh! Oh!’, ‘Stop! Stop!’, and ‘Danger! Danger!’ and sounds of tapping on the vehicle body.

The second determiner 132 proceeds with learning for determining whether a dangerous situation has occurred using information input from an image sensor (e.g., the camera sensor). The second determiner 132 performs machine learning by extracting and vectorizing actions or facial expressions that occur in dangers situations. The actions or facial expressions that occur in dangerous situations include abnormal actions such as tapping on the vehicle body by a passenger or abnormal facial expressions (e.g., a startled look, asymmetrical movements, involuntary twitches, exaggerated expressions, and displays of fear or anxiety, etc.).

The second determiner 132 proceeds with learning for determining whether a dangerous situation has occurred using information input from the vibration sensor. The second determiner 132 performs machine learning by extracting and vectorizing vibrations that occur in dangerous situations. The vibrations that occur in dangerous situations include, for example, repetitive and strong vibrations and vibrations caused by a person tapping on a vehicle body or vibrations resulting from physical altercations.

The second determiner 132 can merge or aggregate and process data input from the second sensing unit 131 by assigning weights to the data and concatenating the data. The second determiner 132 can assign the lowest or relatively lower weight to the data collected from vision-based sensors (e.g., the camera sensor, fisheye lenses, or night vision cameras, etc.) among data collected from different sensors. By assigning the lowest or relatively lower weight to the data collected from the vision-based sensors, it is possible to mitigate the problem of accumulation of errors in the vision-based sensors in narrow spaces and the problem of limited detection capability for individuals positioned in close proximity to, for example, a camera's field or view.

The second determiner 132 determines whether a hazardous condition exists by analyzing data input from the second sensing unit 131. The second determiner 132 can determine whether a hazardous condition has occurred by analyzing integrated data or fused sensor data. The second determiner 132 determines whether a hazardous condition has occurred based on AI-based assessment (e.g., the artificial intelligence algorithm). The artificial intelligence algorithm may be a neural network algorithm. The neural network algorithm may be a deep neural network (DNN) or a convolutional neural network (CNN) and may include both of the deep neural network and the convolutional neural network. The artificial intelligence algorithm may be a model trained in accordance with a supervised learning method or an unsupervised learning method based on an artificial intelligence algorithm based on deep learning. The second determiner 132 can also determine whether a dangerous situation has occurred based on transfer learning. The second determiner 132 can also determine whether a hazardous condition has occurred using a pre-trained DNN. The second determiner 132 can determine whether a dangerous situation or a hazardous condition has occurred by performing objection detection using a DNN. The second determiner 132 can determine whether a dangerous situation has occurred by performing objection detection using an object detection model.

The second determiner 132 can determine the degree of danger (e.g., severity level of a hazardous condition) by analyzing input data. The second determiner 132 can determine the degree of danger by classifying the class of a dangerous situation into multiple categories (e.g., ‘High’, ‘Medium’, or ‘Low’, etc.). The second determiner 132 can also classify the class using a probabilistic scoring function (e.g., Softmax function, sigmoid, or decision tree-based classification, etc.). The second determiner 132 can determine the degree of danger (e.g., hazard severity) by calculating a confidence score and an emergency score (urgency score) and classifying each class into predefined risk categories (e.g., ‘High’, ‘Medium’, or ‘Low’, etc.). In this case, the confidence score is a value that evaluates the reliability and/or certainty of input data, and can be calculated using a probabilistic function (e.g., Softmax function, Bayesian inference, or entropy-based confidence estimation, etc.). In this case, the emergency score is a value that evaluates the degree of urgency of a dangerous situation or a hazardous condition, and can be calculated using a risk assessment function (e.g., Softmax function, fuzzy logic, or reinforcement learning-based prioritization, etc.).

The controller 133 controls the vehicle based on the determination result by the second determiner 132. For example, the controller 133 may execute corrective actions based on the hazard level. When the second determiner 132 determines that it is a dangerous situation, the controller 133 may initiate mitigation actions (e.g., brake the vehicle, for example, by activating emergency brakes, alert the driver or surrounding vehicles about the dangerous situation, flashing hazard lights, etc.). The controller 133 can alert the driver about the dangerous situation by showing the degree of danger using an output device. For example, a visual display on the vehicle's dashboard or infotainment screen could show a graded danger level, using color-coded warnings or a numerical scale. An audible alarm, such as a progressively louder tone or a spoken warning, could also be used. Haptic feedback, like vibrations in the steering wheel or seat, could provide a physical alert. Additionally, a head-up display projecting warning onto the windshield may reduce driver distraction.

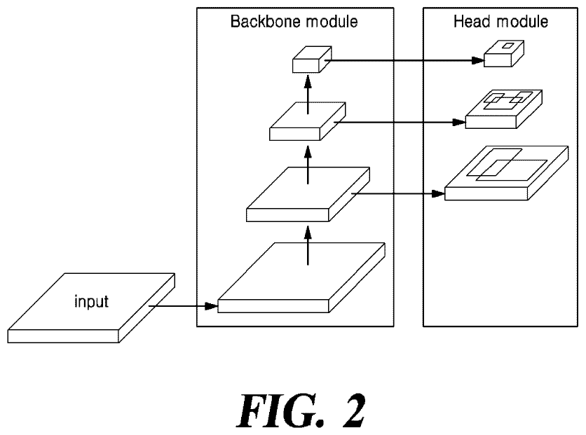

FIG. 2 is a view showing an example of an object detection model that is used in the operation process of the apparatus for autonomous control according to an example of the present disclosure.

The object detection model includes a backbone module and a head module.

The backbone module functions as a feature extractor of a neural network. The backbone module extracts a feature map (e.g., feature representation) from input data using a pre-trained deep learning model (e.g., CNN model, DNN model, Vision Transformers, etc.). The backbone module may be implemented by various architectures (e.g., VGG16, ResNet-50, Darknet53, EfficientNet, or Swin Transformer, etc.).

The head module receives the feature map extracted by the backbone module and performs prediction (e.g., category prediction, dense prediction, or sparse prediction, etc.) for object detection. The head module performs object classification and bounding box regression (e.g., spatial boundary estimation). The head module includes a dense prediction module and a sparse prediction module. The dense prediction module uses the same layer to perform object detection. The dense prediction module may be implemented using various models, for example, such as You Only Look Once (YOLO) or an Single Shot Detector (SSD), etc. The sparse prediction module uses the separate layers to perform object detection. The sparse prediction module may be implemented by a Faster Region-based Convolutional Neural Network (R-CNN), an Region-based Fully Convolutional Network (R-FCN), etc.

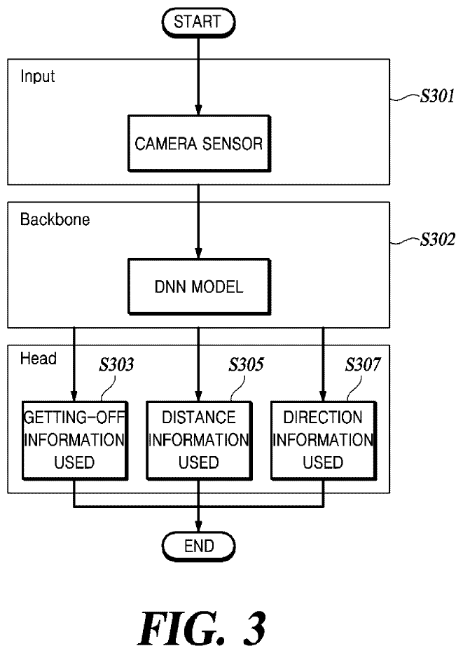

FIG. 3 shows an example of a method in which the apparatus for autonomous control according to an example of the present disclosure determines whether a passenger checks a dangerous situation or engaged in hazard assessment based on an AI-based recognition framework (e.g., using object detection model).

The apparatus for autonomous control performs machine learning in advance to be able to determine whether a passenger checks a dangerous situation. For example, the apparatus for autonomous control performs machine learning in advance to be able to determine whether a passenger checks a dangerous situation or actively monitoring the surroundings for hazards by analyzing whether the passenger has gotten off or exited the vehicle, the distance between the passenger and the vehicle, the direction that the passenger faces (e.g., the orientation of the passenger's gaze), etc. A pre-trained model may be a deep learning framework (e.g., DNN, CNN, or Transformer-based model, etc.)

The apparatus for autonomous control collects and processes sensory inputs (e.g., data from a camera sensor (S301)). For example, the apparatus for autonomous control analyzes the data collected using the camera sensor based on AI-driven recognition framework (e.g., an object detection model).

The apparatus for autonomous control extracts a feature map from input data using a deep learning framework (e.g., the DNN model (S302)). The apparatus for autonomous control uses data collected from the camera sensor as input to the backbone module. The apparatus for autonomous control can extract information for determining whether a passenger is checking a dangerous situation or monitoring a hazardous condition. The apparatus for autonomous control extracts departure status (e.g., getting-off information) for determining whether a passenger has exited the vehicle, relative positioning data (e.g., distance information) for determining the distance between the passenger and the vehicle, direction information for determining the gaze or body orientation of the passenger (e.g., the direction that the passenger faces, etc.).

The apparatus for autonomous control uses the feature map extracted by the backbone module as input to the head module. The apparatus for autonomous control determines whether the passenger is checking a dangerous situation or actively monitoring a hazardous condition using the feature map.

The apparatus for autonomous control specifies a monitoring target using getting-off information (S303). If the apparatus for autonomous control senses opening of any door of the vehicle other than the driver's door and senses a passenger who has exited the vehicle within a first preset time (e.g., within 5 seconds, within 10 seconds, etc.), the apparatus for autonomous control specifies the passenger who has exited as a monitoring target. If the apparatus for autonomous control senses opening of any door of the vehicle other than the driver's door and does not sense a passenger exiting the vehicle within the first preset time, the apparatus for autonomous control determines that the passenger has not existed the vehicle, and does not specify the passenger as a monitoring target.

The apparatus for autonomous control determines whether to stop monitoring the passenger as the monitoring target using distance information (S305). If the monitoring target (e.g., a passenger) does not move a preset distance or more from the vehicle (e.g., within 5 meters, within 3 feet, or based on adaptive tracking models, etc.), the apparatus for autonomous control determines that the passenger is checking a dangerous situation or engaged in monitoring the surrounds of the vehicle for hazard assessment, and proceeds with monitoring the passenger. If the monitoring target (the passenger) moves the preset distance or more from the vehicle, the apparatus for autonomous control determines that the passenger is not checking a dangerous situation or not engaged in monitoring the surrounds of the vehicle for hazard assessment, and stops monitoring the passenger.

The apparatus for autonomous control determines whether to stop monitoring the passenger using direction or orientation information (S307). If the direction that the monitoring target (the passenger) faces is toward the vehicle for a second preset time or more, the apparatus for autonomous control determines that the passenger (the monitoring target) is checking a dangerous situation or engaged in monitoring the surrounds of the vehicle for hazard assessment, and proceeds with monitoring the passenger. If the direction that the monitoring target (the passenger) faces is not toward the vehicle for the second preset time or more, the apparatus for autonomous control determines that the passenger is not checking a dangerous situation or not engaged in monitoring the surrounds of the vehicle for hazard assessment, and stops passenger monitoring. The apparatus for autonomous control can determine the orientation of the monitoring target using various techniques (e.g., head pose estimation, gaze tracking, skeletal motion analysis, etc.).

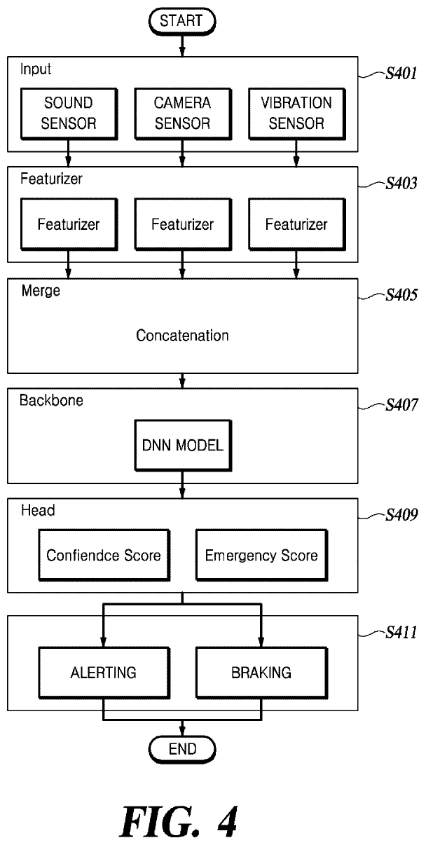

FIG. 4 shows an example of a process in which the apparatus for autonomous control according to an example of the present disclosure determines whether a dangerous situation has occurred based on an object detection model.

The apparatus for autonomous control performs machine learning in advance to be able to determine whether a dangerous situation a hazardous condition has occurred. For example, the apparatus for autonomous control performs machine learning in advance (e.g., trains machine learning model) to be able to determine whether a dangerous situation or a hazardous condition has occurred by analyzing information from various sensory inputs (e.g., inputs from a sound sensor, vision-based sensor, a vibration sensor, or LiDAR, radar, etc.). A pre-trained model may be a deep learning framework (e.g., DNN model, CNN model, or Transformer-based model, etc.).

The apparatus for autonomous control collects data (e.g., real-time sensory data) using a plurality of sensors (S401) (e.g., acoustic sensors, optical sensors, motion sensors, or haptic feedback sensors, etc.). The apparatus for autonomous control can collect data using a sound sensor, a vision-based sensor, and a vibration sensor. The apparatus for autonomous control analyzes the data collected using the sensors based on AI-based object recognition framework (e.g., an object detection model).

The apparatus for autonomous control can featurizing the collected data using the sensors (S403). The apparatus for autonomous control can extract information for determining a dangerous situation or a hazardous condition by featurizing the data (e.g., performing data transformation and feature extraction). The apparatus for autonomous control may derive structured information for hazard identification by applying feature extraction techniques (e.g., spectral analysis, principal component analysis, or neural embedding, etc.).

The apparatus for autonomous control can integrate and prioritize the collected data by assigning weights to the data collected from the sensors and concatenating the data (S405). The apparatus for autonomous control can assign the lowest or relatively lower weight to the data collected from vision-based sensory inputs (e.g., RGB cameras, night-vision sensors, or fisheye cameras, etc.) to mitigate sensor inaccuracies in low-visibility conditions (e.g., narrow spaces, foggy environments, or areas with reflective surfaces, etc.).

The apparatus for autonomous control extracts a feature map or generate a feature-rich representation from input data using a deep learning framework (e.g., DNN model) (S407). The apparatus for autonomous control uses the integrated data as input to the backbone module for extracting features. The apparatus for autonomous control can extract information for determining whether a dangerous situation or a hazardous event has occurred. For example, the apparatus for autonomous control extracts auditory warning sounds (e.g., sounds generated by a passenger, verbal shouts, impact sounds, or emergency signals, etc.), haptic disturbances (e.g., vibrations caused by the passenger, surface vibrations, mechanical shocks, or abrupt vehicle body movements, etc.), facial expressions (e.g., distress indicators, sudden reactions, or visually detectable panic, etc.) of the passenger, actions of the passenger (e.g., physical gestures such as waving, running toward the vehicle, or emergency stop signals, etc.), etc. as information for determining whether a dangerous situation or a hazardous event has occurred.

The apparatus for autonomous control uses the feature map extracted by the backbone module as input to the head module for deciding if a dangerous situation or a hazardous event has occurred. The apparatus for autonomous control determines whether a dangerous situation or a hazardous event has occurred using the feature map. The apparatus for autonomous control can also determine whether a dangerous situation or a hazardous event has occurred based on adaptive learning strategies (e.g., transfer learning, reinforcement learning, or incremental learning, etc.).

For example, if the apparatus for autonomous control senses repetitive and relatively intense auditory cues generated by a passenger or a bystander (e.g., ‘Oh! Oh! Oh! Oh!’, ‘Stop! Stop!’, or ‘Danger! Danger!’, etc.) or physical interaction cues generated by a passenger or a bystander (e.g., sounds of tapping or knocking on the vehicle body, or banging on windows) during passenger monitoring, etc.), the apparatus for autonomous control determines the sounds to be sounds related with a dangerous situation or a hazardous situation, and determines that a dangerous or hazardous situation exist. As another example, if the apparatus for autonomous control senses an abnormal action or an abnormal facial expression of a passenger or a bystander (e.g., unexpected gestures, erratic body movements, or signs of distress, etc.) during passenger monitoring, the apparatus for autonomous control determines the action or facial expression to be an action or facial expression related with a dangerous or hazardous situation and determines that a dangerous or a hazardous situation exist. As another example, if the apparatus for autonomous control senses that taps on the vehicle body or repeatedly generates strong vibrations during passenger monitoring (e.g., aggressive tapping, strong external vibrations, or mechanical shocks, etc.), the apparatus for autonomous control determines the vibrations to be vibrations occurring in a dangerous situation or a hazardous situation and determines that a dangerous situation or a hazardous situation exist.

The apparatus for autonomous control can determine or quantify the degree of danger or the severity of the detected danger or hazard by analyzing data (S409). The apparatus for autonomous control can determine the degree of danger by classifying the class of a dangerous situation into multiple categories (e.g., ‘High’, ‘Medium’, or ‘Low’, etc.). The apparatus for autonomous control can also classify a class using probabilistic classification techniques (e.g., a Softmax function, decision tree, or Bayesian networks, etc.). The apparatus for autonomous control can determine the degree of danger or the severity of hazard by calculating a confidence score and an emergency score and classifying each class into multiple categories (e.g., ‘High’, ‘Medium’, or ‘Low’). In this case, the confidence score is a value that evaluates the reliability or accuracy of input data, and can be calculated using probabilistic functions (e.g., a Softmax function, entropy estimation, or Bayesian inference, etc.). In this case, the emergency score is a value that evaluates the degree of urgency of a dangerous or hazardous situation, and can be calculated using probabilistic functions (e.g., a Softmax function, entropy estimation, or Bayesian inference, etc.). For example, if the class of the confidence score is ‘Low’, the apparatus for autonomous control determines that the event is not an emergency situation regardless of the emergency score. If the class of the confidence score is ‘Medium’ or ‘High’ and the class of the emergency score is ‘High’, the apparatus for autonomous control determines that the event is an emergency situation or an emergency response is required.

The apparatus for autonomous control controls the vehicle based on the determination of a dangerous or hazardous situation (S411). If determining that a dangerous or hazardous situation exists, the apparatus for autonomous control may activate emergency procedures (e.g., automatically brake the vehicle, alert the driver about the dangerous situation, activate hazard light, generate external waring alerts, etc.). The apparatus for autonomous control can also alert the driver about the dangerous situation by showing the degree of danger using an output device (e.g., dashboard screen, mobile app alert, or vehicle communication system, etc.).

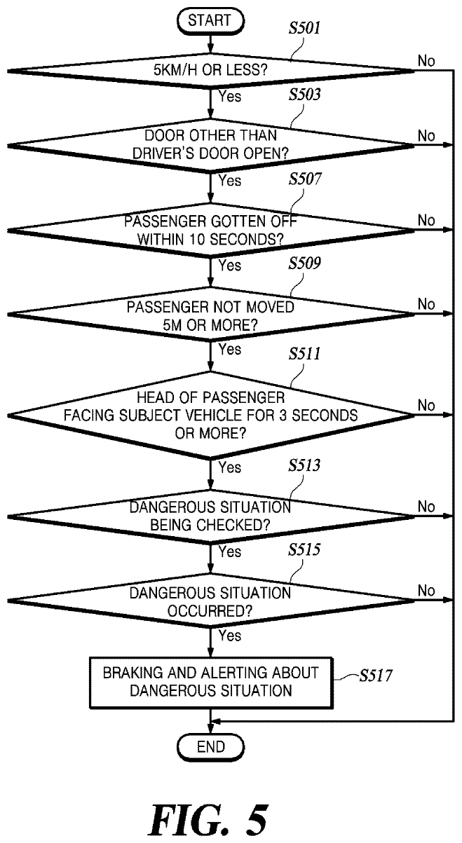

FIG. 5 shows an example of a method for autonomous control according to an example of the present disclosure. The method shown in FIG. 5 can be implemented by a system for autonomous control comprising one or more physical apparatuses (e.g., hardware such as integrated circuit, circuitry, application specific integrated circuits (ASICs), etc.). The following description is given in terms of the operations that are performed by the system for autonomous control.

The system for autonomous control of FIG. 5 is an example under the assumption that a reference for determining whether a vehicle speed is a low speed is set within a predefined threshold (e.g., 5 km/h, 3 mph, or dynamically adjusted based on traffic conditions, etc.). The system for autonomous control is example configured to set a monitoring target (a passenger) based on sensing a passenger who has existed from a vehicle within a predefined time window (e.g., within 10 seconds, within 5 seconds, or based on contextual parameters, etc.) after sensing or detecting opening of a non-driver's door. The system for autonomous control example is configured to stop monitoring the passenger if the passenger has moved away from the vehicle beyond a predefined distance threshold (e.g., 5 meters, 10 feet, or dynamically estimated based on risk factors, etc.). The system for autonomous control is example configured to stop monitoring the passenger if the passenger's orientation is not directed toward the vehicle for a predefined time interval (e.g., 3 seconds, 4 seconds, or dynamically determined based on behavioral analysis, etc.).

The system for autonomous control determines whether the vehicle is operating within a predefined low-speed threshold (S501). For example, if the vehicle speed is 5 km/h or less, the system for autonomous control determines that is the vehicle is in a low speed state. The system may dynamically adjust the low-speed threshold by analyzing historical driving data and real-time traffic conditions (e.g., parking zones, pedestrian-heavy areas, or confined urban spaces, etc.). For example, the system for autonomous control may set, as a low speed threshold, an average speed of the vehicle that is driven in spaces with the possibility of accidents, for example, narrow spaces or parking spaces, by analyzing the driving information of the vehicle.

If the system determines that the vehicle speed does not exceed a low speed threshold (e.g., not 5 km/h or less), the system for autonomous control does not proceed with passenger monitoring or disables passenger monitoring.

If the system determines that the vehicle speed exceeds the low speed threshold (e.g., 5 km/h or less), the system for autonomous control senses or monitor door activity of the vehicle to determine whether a door other than the driver's door is open (S503). If no door of the vehicle other than the driver's door is detected as open, the system for autonomous control does not proceed with passenger monitoring or disables passenger monitoring.

If a door of the vehicle other than the driver's door is detected as open, the system for autonomous control determines whether a passenger has existed the vehicle within a predefined time window (e.g., 10 seconds, 5 seconds, or dynamically adjusted time, etc.) after sensing the opening of the door (S507). If the system determines that the passenger who has existed the vehicle within the predefined time window after sensing the opening of the door of the vehicle, the system for autonomous control determines that the passenger has exited the vehicle. The system for autonomous control specifies or registers the passenger who has exited as a monitoring target and initiates monitoring or monitors the passenger. If the system determines that a passenger who has not exited the vehicle within the predefined time window after sensing the opening of the door of the vehicle, the system for autonomous control determines that the passenger has not exited the vehicle, and does not proceed with passenger monitoring or does not initiate passenger monitoring.

The system for autonomous control determines whether the passenger who has exited the vehicle has moved away from the vehicle beyond a predefined distance threshold (e.g., 5 m or more from the vehicle (S509), within 3 feet, or dynamically estimated based on environmental conditions, etc.). If the system determines that the passenger has moved away from the vehicle beyond the predefined distance threshold, the system for autonomous control determines that the passenger is no longer actively checking a dangerous situation or monitoring the surroundings of the vehicle, and stops or terminates passenger monitoring.

If the system determines that the passenger has not moved away from the vehicle beyond the predefine distance threshold, the system for autonomous control determines the passenger's orientation for at least a predefined duration of time threshold (e.g., whether the head of the passenger has been facing the vehicle for 3 seconds or more, or dynamically computed based on contextual risk factors, etc. (S511)). If the system determines that the passenger's orientation was not maintained for at least the predefined duration of time threshold (e.g., the head of the passenger has not been facing the vehicle for 3 seconds or more), the system for autonomous control determines that the passenger is not checking a dangerous situation or monitoring the surroundings of the vehicle, and stops or terminates passenger monitoring.

If the system determines that the passenger's orientation has been maintained for at least the predefined duration of time threshold (e.g., the head of the passenger has been facing the vehicle for 3 seconds or more), the system for autonomous control proceeds or continues with passenger monitoring. The system for autonomous control determines whether the passenger is checking a dangerous or hazardous situation by proceeding with passenger monitoring (S513). The system for autonomous control can determine whether the passenger is checking a dangerous situation or monitoring the surroundings of the vehicle based on a pre-trained deep learning model (e.g., using a pre-trained DNN model). If the system determines that the passenger is not checking a dangerous situation or no longer engaged in monitoring the surroundings of the vehicle, the system for autonomous control stops, discontinue, pause, or terminates passenger monitoring.

If the system determines that the passenger is checking a dangerous situation or actively monitoring a hazardous condition, the system for autonomous control determines whether a dangerous situation or a hazardous condition has occurred (S515). The system for autonomous control performs machine learning in advance to be able to determine whether a dangerous situation or a hazardous condition has occurred by analyzing real-time sensory inputs (e.g., acoustic signals, visual alerts, or haptic feedback from vibrations, etc.), for example, information input from a sound sensor, information input from a camera sensor, information input from a vibration sensor, etc. The system for autonomous control determines whether a dangerous situation or a hazardous condition has occurred using a pre-trained deep learning framework (e.g., DNN model). If the system determines that a dangerous situation or a hazardous condition have not occurred, the system for autonomous control stops, terminates, or discontinue passenger monitoring.

If the system determines that a dangerous situation or a hazardous condition have occurred, the system for autonomous control initiates emergency response procedure (e.g., braking the vehicle and alerting the driver about the dangerous situation or a hazardous condition (S517)). The system for autonomous control can determine the degree of danger or the severity of hazard by using a risk-based scoring system (e.g., a confidence score, an emergency score, adaptive risk estimation, etc.) and classifying the dangerous situation or the hazardous condition into predefined categories (e.g., ‘High’, ‘Medium’, or ‘Low’, etc.) using probabilistic classification methods (e.g., a Softmax function, Bayesian networks, or dynamic thresholding models, etc.). The system for autonomous control can also alert the driver about the degree of danger or the severity of hazard.

The system for autonomous control can determine a dangerous situation a hazardous condition and control the vehicle by analyzing auditory cues (e.g., sounds that are generated by a passenger). If the system detects or senses sounds (e.g., intense vocal warnings) related with a dangerous situation or a hazardous condition (e.g., repetitive and loud sounds, such as ‘Oh! Oh! Oh! Oh!’, ‘Stop! Stop!’, ‘Danger! Danger!’ generated by a passenger or a bystander or sounds of tapping on the vehicle body by a passenger or a bystander, etc.) the system for autonomous control determines that a dangerous situation or a hazardous condition exist, and initiate an emergency procedure (e.g., braking the vehicle).

The system for autonomous control can determine a dangerous situation or a hazardous condition and control the vehicle by analyzing facial expressions (e.g., sudden widening of eyes, a frozen, open-mouthed stare, a tight, strained jaw and furrowed brow, a pale complexion with trembling lips, a vacant, detached stare, etc.) and actions of a passenger or a bystander. If the system senses or detects abnormal actions (e.g., urgent body movements such as rapid pointing, tapping on the vehicle body or windows, frantic waving towards a danger, a sudden backward leap or stumble, crouching low or covering head with arms, a sharply turned head, a frozen posture with tense muscles, etc.) of a passenger or a bystander related with the dangerous situation or the hazardous condition, the system for autonomous control determines that the dangerous situation or the hazardous condition exist, and initiate an emergency procedure (e.g., braking the vehicle and/or alerting the driver of the vehicle, other passengers, or bystanders, etc.).

The system for autonomous control can determine a presence of a dangerous situation or a hazardous condition and control the vehicle (e.g., applying an emergency procedure) by analyzing vibrations (e.g., forceful knocking, aggressive shaking, or external mechanical impact, etc.) caused by a passenger or a bystander. If the system senses or detects a vibration (e.g., tapping on the vehicle body or repetitive and strong vibrations), the system for autonomous control determines that the dangerous situation or hazardous condition exist, and initiate an emergency procedure (e.g., braking the vehicle, and/or alerting the driver of the vehicle, other passengers, or bystanders, etc.).

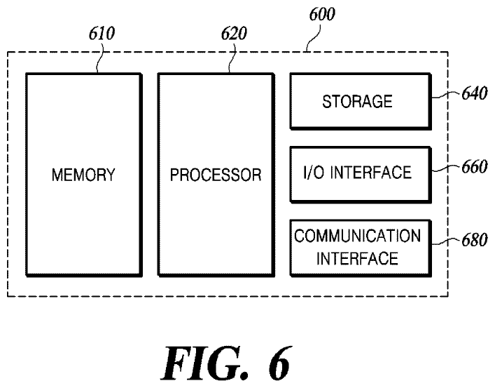

FIG. 6 shows an exemplary computing device that can be used to implement the method according to the present disclosure.

A computing device 600 may include some or all of a memory 610, a processor 620, a storage 640, an I/O interface 660, and a communication interface 680. The computing device 600 may structurally and/or functionally include at least some of the apparatus 10 for autonomous control. The computing device 600 may be not only a stationary computing device such as a desktop computer, a server, and an AI accelerator, but a portable computing device such as a laptop computer and a smartphone.

The memory 610 can store a program causing the processor 620 perform methods or operations according to various examples of the present disclosure. For example, the program may include a plurality of commands that is executable by the processor 620, and the method shown in FIG. 7 can be performed by executing the plurality of command through the processor 620.

The memory 610 may be a single memory or a plurality of memories (e.g., flash memory, solid-state drives (SSDs), or magnetoresistive RAM (MRAM), etc.). In this case, the information for performing the methods or operations according to various examples of the present disclosure may be stored in a single memory or may be separated and separately stored in a plurality of memories. When the memory 610 is composed of a plurality of memories, the plurality of memories may be physically separated.

The memory 610 may include at least one of a volatile or a nonvolatile memory. The volatile memory includes a Static Random Access Memory (SRAM), a Dynamic Random Access Memory (DRAM), or the like, and the nonvolatile memory includes a flash memory, etc.

The processor 620 may include at least one core that can execute at least one command. The processor 620 can execute the commands stored in the memory 610. The processor 620 may be a single processor or a plurality of processors (e.g., multi-threaded CPU, GPU, TPU, FPGA, or neuromorphic chip, etc.).

The storage 640 (e.g., solid-state drives (SSDs), hard disk drives (HDDs), magnetic tapes, optical discs, or cloud-based storage systems, etc.) retains stored data even if power supplied to the computing device 600 is cut off. For example, the storage 640 may include a nonvolatile memory or may include storage media such as a magnetic tape, an optical disc, and a magnetic disc.

The programs stored in the storage 640 can be loaded into the memory 610 before they are executed by the processor 620. The storage 640 can store files written in programming languages, and programs generated from those files by a compiler can be loaded into the memory 610. The storage 640 can store data to be processed by the processor 620 and/or data processed by the processor 620.

The I/O interface 660 may include input devices (e.g., keyboards, mouse, touchscreen displays, or voice recognition systems, etc.) and may include output devices (e.g., monitors, printers, haptic feedback devices, or augmented reality displays, etc.). A user can trigger execution of programs by the processor 620 and/or can check the processing results by the processor 620 through the I/O interface.

The communication interface 680 can provide access to an external network. For example, the computing device 600 can communicate with other devices through the communication interface 680. The communication interface 680 may support wired communication protocols (e.g., Ethernet, USB, or Serial Peripheral Interface (SPI), etc.) or wireless communication protocols (e.g., Wi-Fi, Bluetooth, 5G, Zigbee, or LoRaWAN, etc.). Through the communication interface 680, the computing device 600 may transmit and receive data to and from remote servers, IoT devices, AI-based cloud services, or other autonomous systems.

According to at least an example, the present disclosure provides a method for autonomous control, comprising: determining whether a speed of a vehicle is a preset speed or lower; specifying a passenger as a monitoring target; determining whether the passenger checks a dangerous situation by monitoring the passenger; determining whether a dangerous situation has occurred when the passenger checks a dangerous situation; and controlling the vehicle.

According to another example, the present disclosure provides an apparatus for autonomous control, comprising: at least one memory configured to store commands; and at least one processor, wherein the at least one processor, by executing the commands, determines whether a speed of a vehicle is a preset speed or lower, specifies a passenger as a monitoring target, determines whether the passenger checks a dangerous situation by monitoring the passenger, determines whether a dangerous situation has occurred when the passenger checks a dangerous situation, and controls the vehicle.

Each element of the apparatus or method can be implemented in hardware or software, or a combination of hardware and software. The functions of the respective elements may be implemented in software, and a microprocessor can be implemented to execute the software functions corresponding to the respective elements.

Various examples of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

Although operations are shown in the flowcharts/timing charts in this specification as being sequentially performed, this is merely an exemplary description of the technical idea of one example of the present disclosure. In other words, those having ordinary skill in the art to which the present disclosure pertains may appreciate that various modifications and changes can be made without departing from essential features of examples of the present disclosure, i.e., the sequence shown in the flowcharts/timing charts can be changed and one or more operations of the operations can be performed in parallel. Thus, flowcharts/timing charts are not limited to the temporal order.

Although examples of the present disclosure have been described for illustrative purposes, those having ordinary skill in the art should appreciate that various modifications, additions, and substitutions are possible, without departing from the idea and scope of the claimed present disclosure. Therefore, the examples of the present disclosure have been described for the sake of brevity and clarity. The scope of the technical idea of the present disclosure is not limited by the illustrations. Accordingly, one of ordinary skill in the art would understand that the scope of the claimed present disclosure is not to be limited by the above explicitly described examples but by the claims and equivalents thereof.

What is claimed:

1. A method performed by an apparatus for autonomous control of a vehicle, the method comprising:
determining whether a speed of the vehicle is equal to or less than a preset speed;
specifying a passenger of the vehicle as a monitoring target;
determining, by monitoring the passenger, whether the passenger indicates a potential risk associated with the vehicle;
determining, based on a determination that the passenger indicates the potential risk, whether the potential risk qualifies as a dangerous situation;
generating, based on a determination that the potential risk qualifies as the dangerous situation, a signal indicating the dangerous situation; and
performing, based on the signal, autonomous control of the vehicle.

2. The method of claim 1, wherein the specifying of the passenger as the monitoring target comprises determining that the passenger has exited the vehicle.

3. The method of claim 1, wherein the specifying of the passenger as the monitoring target comprises:
setting, based on a pre-trained artificial intelligence learning model, a first preset time; and
determining that the passenger has exited the vehicle within the first preset time after sensing opening of a door of the vehicle other than a driver's door.

4. The method of claim 3, wherein the determining of whether the passenger indicates the potential risk comprises determining, based on a pre-trained deep neural network model, whether the passenger is checking the potential risk condition.

5. The method of claim 1, wherein the determining of whether the passenger indicates the potential risk comprises stopping monitoring the passenger based on a determination that the passenger is not checking for at least one potential risk.

6. The method of claim 1, wherein the determining whether the passenger indicates the potential risk comprises:
setting, based on a pre-trained artificial intelligence learning model, a preset distance; and
determining, based on the passenger moving at least the preset distance away from the vehicle, that the passenger is not checking for at least one potential risk.

7. The method of claim 1, wherein the determining of whether the passenger indicates the potential risk comprises:
setting, based on a pre-trained machine learning model, a second preset time; and
determining, based on the passenger has been facing away from the vehicle for at least the second preset time, that the passenger is not checking for at least one potential risk.

8. The method of claim 1, wherein the determining of whether the potential risk qualifies as the dangerous situation comprises determining, based on a pre-trained deep neural network model, whether the potential risk qualifies as the dangerous situation.

9. The method of claim 1, wherein the determining of whether the potential risk qualifies as the dangerous situation comprises:
receiving sensing data from a plurality of sensors, wherein the plurality of sensors comprises at least one of a sound sensor, a vision sensor, or a vibration sensor; and
detecting, based on an object detection model and the sensing data, at least one external object associated with the potential risk.

10. The method of claim 9, wherein the determining of whether the potential risk qualifies as the dangerous situation comprises assigning weights to the sensing data and integrating the weighted data.

11. The method of claim 10, wherein the determining of whether the potential risk qualifies as the dangerous situation comprises assigning a weight to sensing data received from the vision sensor that is lower than weights assigned to sensing data received from other sensors of the plurality of sensors.

12. The method of claim 1, wherein the determining of whether the potential risk qualifies as the dangerous situation comprises determining, based on a feature of a sound generated by the passenger, whether the sound is related to the potential risk.

13. The method of claim 1, wherein the determining of whether the potential risk qualifies as the dangerous situation comprises determining, based on a feature of a vibration generated by the passenger, whether the vibration is related to the potential risk.

14. The method of claim 1, wherein the determining of whether the potential risk qualifies as the dangerous situation comprises determining, based on a feature of an action or a facial expression generated by the passenger, whether the action or the facial expression is related to the potential risk.

15. The method of claim 1, wherein the determining of whether the potential risk qualifies as the dangerous situation comprises determining a degree of danger level of the potential risk.

16. The method of claim 1, wherein the determining of whether the potential risk qualifies as the dangerous situation comprises:
determining a confidence score of the potential risk and an emergency score of the potential risk; and
classifying, based on the determining the confidence score and the emergency score, the potential risk into one of a plurality of risk categories.

17. The method of claim 16, wherein the determining of whether the potential risk qualifies as the dangerous situation comprises determining, based on a probabilistic function, the confidence score and the emergency score.

18. The method of claim 1, wherein the performing of the autonomous control of the vehicle comprises performing an emergency procedure, wherein the emergency procedure comprises at least one of braking the vehicle or alerting a driver of the vehicle about the potential risk, and
wherein the alerting the driver comprises outputting an indicator of a degree of the potential risk on an output device.

19. An apparatus for autonomous control of a vehicle, the apparatus comprising:
at least one processor; and
a memory storing at least one instruction that is configured, when executed by the at least one processor communicating with the memory, to cause the apparatus to:
determine whether a speed of the vehicle is equal to or less than a preset speed,
specify a passenger of the vehicle as a monitoring target,
determine, by monitoring the passenger, whether the passenger indicates a potential risk associated with the vehicle,
determine, based on a determination that the passenger indicates the potential risk, whether the potential risk qualifies as a dangerous situation,
generate, based on a determination that the potential risk qualifies as the dangerous situation, a signal indicating the dangerous situation, and
perform, based on the signal, autonomous control of the vehicle.

20. A method performed by an apparatus for autonomous control of a vehicle, the method comprising:
detecting that the vehicle is operating at a speed below a predefined threshold;
collecting sensor data associated with actions of an occupant of the vehicle;
determining, based on the sensor data, whether the occupant, after exiting the vehicle, is assessing surroundings of the vehicle for a potential risk associated with the vehicle;
classifying, based on the sensor data and the determining, the potential risk as a dangerous situation;
generating a signal indicating the dangerous situation; and
performing, based on the signal, autonomous control of the vehicle.
